(19) United States
(12) Patent Application Publication
(10) Pub. No.: US 2025/0287980 A1
(43) Pub. Date: Sep. 18, 2025

(54) VEGETABLE SIDESTREAM VALORISATION

(71) Applicant: UNIVERSITEIT VAN AMSTERDAM, Amsterdam (NL)

(72) Inventor: Jeroen HUGENHOLTZ, Amsterdam (NL)

(21) Appl. No.: 18/702,604

(22) PCT Filed: Oct. 26, 2022
(86) PCT No.: PCT/EP2022/080007

§ 371 Date: Apr. 18, 2024

(30) Foreign Application Priority Data
Oct. 27, 2021 (EP) 21205110.6

(51) Int. Cl. A23L 19/00; A23L 29/00

(52) U.S. Cl. CPC A23L 19/09; A23L 19/01; A23L 29/065; A23V 2400/173

(57) ABSTRACT

The present invention relates to a method for vegetable sidestream valorisation. The method comprises (a) mixing vegetables with a composition comprising Lactobacilli reuteri bacteria; and (b) fermenting the mixture, whereby a vegetable paste is obtained. Fermentation is for 24-44 hours only and there is no need to add water, heat or nutrients.

### FIELD OF THE INVENTION

The present invention relates to a method for the valorisation of food sidestreams and to valuable products produced from food sidestreams, in particular to the valorisation of vegetable sidestreams using Lactobacillus reuteri for the improvement of nutritional value, flavour or shelf life of food products.

### BACKGROUND OF THE INVENTION

Food waste, which refers to food which is not consumed, such as surplus fruit and vegetables which are abandoned or rejected by a farmer or retailer, fruit and vegetables with imperfections or food that is discarded after buying, is becoming a serious problem which is less and less accepted. About one third of the food produced in the world is being thrown away, with World Hunger still on the rise (UN FAO, 2011 report). Food waste also very easily degrades, attracting animals and leading to odour nuisance.

Instead of discarding the food, it has been used as animal feed. CN104982658 describes fruit and vegetable waste residues which are turned into biological feed by sterilizing the waste at 80-100 DEG C for 3-6 hours and subsequently fermenting the waste for 50-70 hours using a mixture of bacteria. In this way, the valuable compounds present in food waste are used to the benefit of animals.

Another way of extracting value from food waste is subjecting it to anaerobic digestion in a fermenter. EP 1 149 805 describes the anaerobic digestion of dehydrated vegetable waste. Anaerobic digestion yields biogas and fertilizer.

By converting food into animal feed, biogas or fertilizer, more value is extracted from food than when food is just discarded, but the food is still lost from the food chain for human consumption. It would be desirable to keep the food in the food chain and reuse it for human consumption.

### DETAILED DESCRIPTION OF THE INVENTION

The present invention relates to a method for fermenting vegetables, the method comprising
(a) providing vegetables;
(b) mixing the vegetables from (a) with a composition comprising Lactobacillus reuteri bacteria,
(c) fermenting the mixture obtained in (b) for 24-44 hours, whereby a vegetable paste is obtained; wherein the mixture is fermented without the addition of water, nutrients, heat or oxygen.

The method has many advantages. A first advantage is that the method allows for high value usage of food which would otherwise be wasted and lost for human consumption. i.e. a valorisation of vegetable sidestreams. The method can be conducted at ambient temperature, i.e. without the addition of heat, without aeration and without prior sterilisation or pasteurisation of the vegetable sidestreams. Yet another advantage is that the method requires relatively little investment, since it does not require expensive or sophisticated equipment and can be applied on the same location where the waste is produced. This also means that transportation may be reduced, and that the method contributes to a smaller carbon footprint than existing methods which require transportation of waste to specialised areas. Since there is no need to add extra water or thermal energy (heat) to the fermenter, the method according to the invention saves a lot of time, costs and energy. The invention also creates a more attractive outlet and additional value for the primary producer and at the same time allows for improved functionalities for various food products.

The product obtained by the method according to the invention may be used in food products, including food ingredients, to improve flavour, nutritional value or shelf-life. It will be clear to the skilled person, that the product obtained by the method according to the invention may also be used to improve feed products, including feed ingredients. Improvement is always relative to a similar food or feed product to which no product according to the invention was added.

In the context of the present invention, the term vegetable includes crops such as aubergines, bell peppers, broccoli, cauliflower, chives, courgettes, cucumber, endive, garlic, leek, lettuce, maize, onions, potatoes, pumpkins, tomatoes. In one embodiment, the vegetable is selected from tomato, bell pepper, broccoli, cabbage. The vegetable material may consists of one type of vegetables, e.g. 100% w/w of tomatoes, 100% w/w of broccoli, 100% w/w of bell peppers or 100% w/w of cabbage. In another embodiment, the vegetable material comprises different vegetables, i.e. is a mixture of vegetables. For example, 70% w/w of bell peppers and 30% w/w of broccoli or 30% w/w of cabbage, based on the total weight of vegetables. In another embodiment, the vegetable mixture comprises, based on the total weight of vegetables, 10-40% w/w of bell peppers, 10-40% w/w of broccoli, 10-40% w/w of tomatoes and 10-40% w/w of white cabbage. In practice, exact vegetable contents will frequently not be known, but the method can still be applied advantageously with good results leading to the product of the invention.

The vegetables are preferably fresh vegetables, i.e. not heated, not sterilized, not pasteurized, not salted, unprocessed. Although pre-treated or processed vegetables can be used in the method according to the invention without losing quality of the end product, pre-treatment is not required and makes it unnecessarily complicated and expensive. The vegetables are only reduced in size, preferably by cutting or blending. The size of the vegetables is preferably 0.1-10 square cm, more preferably 0.1-1.0 square cm, most preferably 0.1-0.2 square cm.

Vegetables may be collected in any type of container, open, semi-open or closed. No light is required. There is no need to apply pressure, add oxygen or shield vegetables from oxygen. Vegetables are preferably fermented as quick as possible, to minimize rotting.

In the method according to the invention preferably vegetables waste is used, i.e. vegetables which are lost for consumption. This includes vegetables which are abandoned by farmers or retailers, or vegetables with imperfections, also referred to as rejected vegetables. In this way, vegetable sidestreams may be valorised using the method according to the invention.

Preferably, vegetables are used as quickly as possible in the process according to the invention to minimize rotting, for example within 1-7 days, within 1-3 days, within 48 hours, within 30 hours, within 24 hours, within 18 hours or within 10 hours after collection, rejection or abandonment.

The vegetables are used as is, only cutting or blending, nothing is added, except for the composition comprising or consisting of Lb. reuteri bacteria, which are able to perform a full fermentation within 44 hours, preferably within 20 to 40 hours or within 20 to 30 hours, more preferably within 24 or 25 hours. Mixing and fermentation take place at ambient temperature. No heating is required and no temperature control is required. Ambient temperature without heating will depend on the local climate and the season, and is preferably in the range of 18 DEG C to 35 DEG C. In one embodiment, the fermentation temperature is in the range of 20 to 30 DEG C or 20 to 25 DEG C. More preferably, fermentation temperature is 23 DEG C. Fermentation takes place at ambient oxygen levels. No exclusion or addition of oxygen is required.

During fermentation, pH is not regulated and will decrease as a result of the formation of acids, in particular lactic acid or acetic acid. These acids are formed during fermentation and present in the fermentation end product. The pH will be between 3 and 4 at the end of fermentation, such as 3.5 to 4.0. In one embodiment, the pH decreases to pH 3.8. Typically, the lowest pH is reached within 44 hours, preferably within 20 to 40 hours or within 20 to 30 hours, more preferably within 24 or 25 hours. Fermentation according to the process of the invention is apparent from an increase in Lb. reuteri CFUs and an increase in lactic acid, acetic acid and reuterin levels, preferably within the first 24 hours. In one embodiment, Lb. reuteri concentration is 10E8-10E9 CFU/ml, within 24 hours. At the end of the fermentation, the lactic acid levels are 2-20 gr/l, acetic acid levels are 1-5 gr/l and reuterin levels are preferably 1-50 mM. Vitamin B12 levels after fermentation are preferably 1-8 microgram/l paste, for example 2-5 microgram/l paste. Preferably, no propionic acid is formed and propionic levels are below 0.2 g/l. Metabolite levels, such as levels of glucose, fructose, lactic acid, acetic acid, propionic acid, mannitol or reuterin, may be determined using any convenient method. In one embodiment, metabolite levels are determined by HPLC. CFUs are preferably determined by bacterial plate count.

The vegetables are preferably mixed with a composition comprising or consisting of Lb. reuteri. No addition of other bacteria is required. Any Lb. reuteri strain may be used. Lb. reuteri, which is capable of producing the broad spectrum antibiotic reuterin (3-hydroxypropionaldehyde) if fermented on glycerol, may be isolated from suitable sources, such as from the gastrointestinal tract of humans or animals, or may be obtained from international strain collections of microorganisms, for example from DSMZ (DSMZ, Braunschweig, Germany) or ATCC (ATCC, Manassas, VA, USA. Preferred are Lb. reuteri strains which are capable of producing vitamin B12. Such Lb. reuteri strains contain a functionally active vitamin B12 biosynthetic gene cluster which encodes all the enzymes required for the synthesis of vitamin B12. Lb. reuteri strains capable of producing vitamin B12 are known in the art and include Lb. reuteri ATCC 55730, Lb. reuteri ATCC 6475 Lb. reuteri CRL 1098, Lb. reuteri DSM 12246, Lb. reuteri DSM 16143, Lb. reuteri DSM 17938, Lb. reuteri DSM 20016/JCM1112, Lb. reuteri DSM 23877, Lb. reuteri DSM 23878, Lb. reuteri DSM 23879, Lb. reuteri DSM 23880.

Vitamin B12 or cobalamin refers to any form of vitamin B12, such as cyanocobalamin, hydroxocobalamin, methylcobalamin or 5′-deoxyadenosylcobalamin, which differ in the group binding to the cobalt. Assays for determining cobalamin concentrations are known in the art, such as bioassays, HPLC or LC/MS. Suitable bioassays include growing microorganism which require cobalamin for growth in vitamin B12 free medium, such as the L. delbrueckii assay. If LC/MS is used, preferably a Waters® Atlantis™ C18 column is used combined with a Waters Micromass® ZQ™ 4000 single quadrupole mass spectrometer for detection. The method uses a binary acetonitrile/water gradient without the need for a buffer or ion pairing reagents (Waters Corporation, Milford, US).

The composition may consist of or comprise Lb. reuteri. In one embodiment, the composition comprises at least 50% w/w, at least 60% w/w, at least 70% w/w, at least 80% w/w, at least 90% w/w or at least 95% w/w bacteria, based on the dry weight of the composition, such as between 90% w/w and 99.8% w/w or between 95% w/w and 99% w/w. All bacteria in the composition are Lb. reuteri. In one embodiment, one strain of Lb. reuteri is used. In another embodiment, mixtures of Lb. reuteri strains are used.

In the context of the present invention, dry weight or matter may be determined by methods known in the art and typically comprises removing all, or at least 98%, at least 99%, of the moisture in a sample, for example by drying a representative sample to constant weight in an oven and comparing the weight of the sample before and after drying. Drying may take from several minutes to several hours, for example from 10 minutes to 24 hours, depending on the drying temperature, the moisture content and size of the sample. In one embodiment, dry weight is determined by drying a 1-100 ml sample for about 2-24 hrs at 90-105 DEG C in a conventional oven until constant weight is achieved. For wet weight determination, no drying is required, usually just separation from the broth.

In one embodiment, the composition which is added to the vegetables is the wet biomass (or pellet) of a fermentation of a Lb. reuteri monoculture. In one embodiment, the wet biomass is biomass of the fermentation which is washed with physiological saline before being added to the vegetables. Preferably, the wet biomass is added to the fresh vegetables to reach a concentration of 0.1% w/w-5% w/w, such as 1% w/w-5% w/w or 3% w/w-5% w/w, based on the weight of the fresh vegetables. No addition of extra water is required.

Lb. reuteri have the advantage that they make several vitamins, such as folate, biotin, riboflavin and vitamin B12, and antifungal compounds such as lactic acid and acetic acids. Another advantage is that scaling up is relatively easy and can be done reliably with Lactobacilli. This is partly due to the fact that these cultures do not require aeration.

The vegetable paste which is obtained by the method according to the invention is another aspect of the invention. The vegetable paste has a very pleasant fermented flavour. This is achieved without adding extra water, nutrients, herbs, spices or seasonings or other microorganisms than Lb. reuteri. The vegetable paste will comprise cobalamin, reuterin, lactic acid and acetic acid, which account for the nutritional value and antifungal action of the vegetable paste end product. In one embodiment, the vegetable paste has a dry matter content of at least 50% w/w, preferably, the paste has a dry matter content of at least 55% w/w, at least 60% w/w, at least 65%, at least 70% w/w or at least 75% w/w, up to 80% w/w, for example a dry matter content between 55% w/w and 80% w/w, between 55% w/w and 70% w/w or between 55% and 65% w/w. Dry matter content of the paste may be determined by methods known in the art, as described above.

The vegetable paste may be used as such or may be formulated into a liquid or powder. Preferably, the vegetable paste is dried which also allows for killing off any microorganisms. Spray drying or freeze-drying are preferred drying techniques.

Paste, powder or liquid obtained may be used in food or feed applications, such as in food or feed products, including food or feed ingredients, preferably in vegetable food products.

Use of the vegetable paste according to the invention, optionally after formulation as a powder or liquid, has enormous advantages, because the vegetable paste may be used as a food ingredient to add or improve flavour, to increase nutritional value, to increase vitamin content or shelf-life of known and novel food products or as a meat alternative, since it has a very pleasant fermented flavour and is enriched in vitamin B12. The vegetable paste may be added to food products, optionally after complete or partially drying, such as to soups, sauces and spreads, and in particular to food products which contain vegetable blends. Suitable concentrations depend on the food or feed application. In one embodiment, concentrations vary between 1 and 10% w/w, based on dry weight of the food or feed. In one embodiment, the paste is used as a flavour base, equivalent to a stock, but in vegetable form, for use as a base for soups, sauces or stews. Of course, bones could be added to the paste, if desired. In another embodiment, the vegetable paste is used to increase the vitamin B12 content of meat alternatives, such as vegetable or vegetarian products. In another embodiment, the vegetable paste is used in or as a meat alternative. In another embodiment, the vegetable paste is used to increase the flavour of food for people who lost taste or smell, such as people undergoing chemotherapy, senior people or people with anosmia or hyposmia. In another embodiment, the paste is used to simultaneously increase flavour, vitamin content and shelf-life of a food product. These modified food or feed products with increased vitamin B12 content, increased flavour or increased shelf-life, which have been modified by adding the powder, paste or liquid according to the invention, are also an aspect of the present invention.

### EXAMPLES

### Determination of Metabolites

Metabolite levels, such as levels of glucose, fructose, lactic acid, acetic acid, propionic acid, mannitol or reuterin were determined by HPLC. Vitamin B12 analysis (Table 6) was performed using an LC/MS Waters® Atlantis™ C18 column combined with a Waters Micromass® ZQ™ 4000 single quadrupole mass spectrometer for detection (Waters Corporation, Milford, US).

### Example 1 Lab Scale Fermentation Lactobacillus reuteri

Approximately 30 gram freshly blended (Thermomix TM5, Cnudde BV, The Netherlands) tomatoes were fermented with 1.5 ml of a freshly grown and washed pre-culture of Lactobacillus reuteri at 23° C. or 30° C., fresh (F) or with (S) a pre-treatment of pasteurisation for 10 minutes at 100 DEG C. Results are presented in Table 1 (control, without inoculation), Table 2 (30 DEG C) and Table 3 (23 DEG C) and show that glucose and fructose are both simultaneously converted, fructose slightly faster than glucose, and show that fresh (non-heat-treated) tomato is fermented more rapidly than pasteurised tomato and that fermentation with Lb. reuteri is faster at 30 DEG C than at 23 DEG C. Besides lactic acid and acetic acid, also mannitol is a major fermentation product with production levels up to 14 gr/l.

F: fresh, vegetables are used “as is”, i.e. without a heat treatment, no addition of extra water or nutrients, only cutting or blending; S: pasteurisation for 10 minutes at 100 DEG C; n.d. not determined.

TABLE 1
control tomato fermentation 30 DEG C.

| | | | (g/l) | | | | | | | | | |
|---|---|---|---|---|---|---|---|---|---|---|---|---|
| | pH | | glucose | | fructose | | lactic acid | | acetic acid | | mannitol | |
| Sample | S | F | S | F | S | F | S | F | S | F | S | F |
| at start | 4.20 | | 14.5 | | 14.1 | | 0 | | 0 | | | |
| 2 days | 4.20 | 4.11 | 13.0 | 10.4 | 16.5 | 13.0 | 0 | 0.3 | 0 | 0 | n.d. | n.d. |
| 4 days | 4.20 | 4.04 | 1.4 | 5.60 | 2.6 | 10.7 | 0 | 1.0 | 0 | 0 | n.d. | n.d. |
| 6 days | 4.52 | 3.74 | 1.8 | 0 | 0 | 1.6 | 0 | 3.4 | 0 | 0 | n.d. | n.d. |

TABLE 2
Lb. reuteri tomato fermentation 30 DEG C.

| | | | (g/l) | | | | | | | | | |
|---|---|---|---|---|---|---|---|---|---|---|---|---|
| | pH | | glucose | | fructose | | lactic acid | | acetic acid | | mannitol | |
| Sample | S | F | S | F | S | F | S | F | S | F | S | F |
| Control | 4.20 | | 14.5 | | 14.1 | | 0 | | 0 | | | |
| 2 days | 3.91 | 3.85 | 9.1 | 1.8 | 7.5 | 3.1 | 1.6 | 4.5 | 1.0 | 2.0 | n.d. | n.d. |
| 4 days | 3.75 | 3.74 | 5.0 | 0 | 2.6 | 0 | 2.6 | 5.5 | 1.8 | 2.3 | n.d. | n.d. |
| 6 days | 3.71 | 3.72 | 4.8 | 0 | 0 | 0 | 3.0 | 5.7 | 2.0 | 2.3 | 14.3 | 11.7 |

TABLE 3
Lb. reuteri tomato fermentation 23 DEG C.

| | | | (g/l) | | | | | | | | | |
|---|---|---|---|---|---|---|---|---|---|---|---|---|
| | pH | | glucose | | fructose | | lactic acid | | acetic acid | | mannitol | |
| Sample | S | F | S | F | S | F | S | F | S | F | S | F |
| Control | 4.20 | | 14.5 | | 14.1 | | 0 | | 0 | | | |
| 2 days | 4.11 | 3.94 | 10.9 | 4.7 | 12.3 | — | 0.7 | 4.2 | 0.4 | 2.1 | n.d. | 11.9 |
| 4 days | 4.06 | 3.82 | 9.3 | 3.5 | 11.3 | 3.2 | 0.8 | 5.1 | 0.4 | 2.3 | n.d. | 11.4 |
| 6 days | 3.80 | 4.04 | 1.9 | 03.1 | 0 | 5.0 | 5.2 | 1.0 | 2.2 | 0.4 | 14.3 | 9.2 |

The vitamins usually produced after fermentation with Lb. reuteri were present, in particular folate, biotin, riboflavin and vitamin B12. The vitamin B12 content in the tomato paste after fermentation with Lb. reuteri was 3 microgram/kg paste. Similar results were found for the fermentation of bell pepper and white cabbage.

In conclusion, a good, precision, fermentation can be performed on vegetables using Lactobacillus reuteri (for vitamin B12 production and antifungal and reuterin production) even without heat treatment, without extra water addition to the vegetables and even at room temperature.

### Example 2 Fermentation of Mixed Vegetables

This experiment demonstrates that the method of the invention also works for mixed vegetables.

Fresh vegetables (white cabbage, tomato, red pepper, broccoli) were blended in a 1:1:1:1 ratio in weight using a household blender. Immediately after blending the blended vegetable mixture was distributed in 50 g portions in sterile plastic cups and stored at −40 DEG C until the start of the fermentation experiment. Lactobacillus reuteri DSM strain 122.46 was cultivated, overnight, in standard MRS medium (Sigma-Aldrich, Steinheim, Germany). Cells from the full-grown culture were collected by centrifugation, washed and resuspended in the same volume of 50 mM potassium phosphate buffer of pH 6.8. For fermentation, the fresh, i.e. non-heat-treated, blended, vegetable mix was inoculated with the overnight, washed, culture of Lb. reuteri (5% w/w, on wet weight) and subsequently incubated, in duplicate, at room temperature (22 DEG C) and 30 DEG C. To investigate the requirement of extra glucose-addition, vegetable mix with extra 2% w/w (on wet weight) glucose was also incubated at both temperatures. As a control, the fresh, non-sterilized, vegetable mix was also incubated at the two temperatures without inoculation with Lb. reuteri.

The results were performed in duplicate and mean values are shown in Table 4. A decrease in pH is an indication of the formation of acid products, and thus an indication of fermentation. The blended vegetable mix was almost completely fermented (pH decrease from 4.8 to below 4.0) in 24 hours of incubation, even if no sugar was added. In the state of the art, nutrients are typically added to stimulate fermentation. However, the results show that not adding glucose had no significant effect on the acidification or cell growth, which is very practical and cost-efficient.

TABLE 4
pH of fermentation of vegetable mix inoculated with Lb reuteri

| | Lb. reuteri | | | | Control | | | |
|---|---|---|---|---|---|---|---|---|
| | 22 DEG C. | | 30 DEG C. | | 22 DEG C. | | 30 DEG C. | |
| Hours | | +glucose | | +glucose | | +glucose | | +glucose |
| 0 | 4.80 | 4.80 | 4.80 | 4.80 | 4.88 | 4.88 | 4.88 | 4.88 |
| 24 | 3.95 | 3.95 | 3.84 | 3.69 | n.d. | n.d. | n.d. | n.d. |
| 39 | 3.93 | 3.90 | 3.80 | 3.74 | 4.62 | 4.63 | 4.56 | 4.55 |
| 48 | 4.11 | 3.77 | 3.80 | 3.30 | 4.60 | 4.60 | 4.54 | 4.53 |

TABLE 5
Metabolite formation and cell growth in vegetable mix fermented with Lb reuteri.

| | | Lb. reuteri | | | | Control | |
|---|---|---|---|---|---|---|---|
| | | 22 DEG C. | | 30 DEG C. | | 22 DEG C. | |
| Hours | gram/l | | +glucose | | +glucose | | +glucose |
| 0 | Glu | 14.6 | 35.1 | 14.6 | 35.1 | 14.6 | 35.1 |
| | Fru/Xyl | 11.3 | 11.5 | 11.3 | 11.5 | 11.3 | 11.3 |
| 24 | Glu | 2.5 | 22.8 | 1.8 | 22.3 | 14.5 | 35.3 |
| | Fru/Xyl | 11.0 | 11.5 | 11.1 | 11.5 | 11.2 | 11.1 |
| | LA | 5.9 | 5.9 | 6.2 | 6.7 | 0.0 | 0.0 |
| | AA | 3.0 | 3.1 | 3.2 | 3.4 | 0.3 | 0.4 |
| | CFU (10⁸/ml) | 8.9 | 8.7 | 9.2 | 9.3 | n.d. | n.d. |
| | culture | mono | mono | mono | mono | n.d. | n.d. |
| 48 | CFU (10⁸/ml) | 2.1 | 8.2 | 5.5 | 7.1 | 0.0035 | 0.0051 |
| | culture | mono | mono | mono | mono | mixed | mixed |

Glu = glucose; Fru/Xylose = fructose or xylose; LA = lactic acid; AA = acetic acid

The results also show that, using the method of the invention, adding heat is not required for fermentation. Both at room temperature and at 30 DEG C the blended vegetable mix was almost completely fermented (pH decrease).

The observed fermentation was clearly caused by the addition of the Lb. reuteri pre-culture, since the controls showed very little acidification. The pH showed hardly any decrease and remained above pH 4.5, with or without the addition of extra glucose. Table 5 shows the formation of acids and the bacterial growth during fermentation. The control (not-inoculated) shows no clear production of lactic acid or acetic acid and very limited growth of bacteria.

As to sugar consumption and metabolite formation, with and without addition of extra glucose, the amount of glucose consumed during 24 hours of fermentation was approximately 12-13 g/L leading to production of approximately 6 g/L of lactic acid and 3 g/L of acetic acid. Fermentation at 30 DEG C was slightly faster and slightly more extensive than at room temperature, leading also to slightly higher utilization of glucose and slightly higher production of lactic acid and acetic acid.

The cell growth of Lb reuteri occurred in the first 24 hours until about 10E9 CFU (colony forming units) per ml of fermented vegetable. Longer incubation did not lead to higher outgrowth of the culture and clear reduction of cell counts was observed, especially at room temperature and in the absence of extra glucose. The observed outgrowth of 10E9 Lb. reuteri cells/ml resulted in production of 5 microgram/L vitamin B12 production.

The results demonstrate that fresh vegetables and vegetable sidestreams can be readily fermented with Lb. reuteri without the need for temperature treatment or heating, extra water addition or sugar addition. The ferment contained the same amount of metabolites (lactic acid and acetic acid) and cell numbers with and without the addition of extra sugar, at both incubation temperatures. Using the method of the invention, the fermented vegetables had a very pleasant fermented flavour and were enriched in vitamin B12 as a result of the presence and growth of Lb. reuteri. No addition of other bacteria, heat, oxygen or nutrients was required.

### Example 3 Pilot Scale Vegetable Blend Fermentation

For a pilot scale fermentation, a pre-culture of Lactobacillus reuteri (DSM 1224, DSMZ, Braunschweig, Germany) was grown in MRS medium (Sigma-Aldrich, Steinheim, Germany) at 37 DEG C until OD600 of 2.0 was reached and used to inoculate a 2 liter overnight culture. The next day, the microbial biomass of the 2 liter culture was collected by centrifugation (at 10 000 g for 10 min) and washed using sterile saline solution (0.9% NaCl).

Approximately 150 kg fresh vegetable mixture (tomato, bell pepper, broccoli, white cabbage) was cut in pieces of approximately 1-2 square mm and mashed using a Finis Cutter pinned grater (“spijkerrasp”, FINIS, Ulft, the Netherlands) to form a vegetable puree with 5.1% dry matter. The puree was fed into a sanitized 100 liter fermenter without heat treatment and without the addition of extra water. The biomass of the 2 liter overnight culture Lactobacillus reuteri was added. No other nutrients were added. The mixture of vegetable puree and bacterial biomass was incubated under stirring (400 rpm) at 30 DEG C. The pH value at the start was approximately 5.8. During fermentation, pH, stirring speed and temperature were monitored automatically. Within 24 hours, the broth reached its lowest pH value (pH 3.8), indicating that fermentation was completed within 24 hrs. After 44 hrs, fermentation was stopped. The acidic pH at the end of fermentation was mainly due to the lactic acid and acetic acid formed. The resulting vegetable paste was analysed.

Metabolite analysis confirmed that after one day most fermentation had taken place with utilisation of glucose and not of fructose. Lactic acid and acetic acid were formed. No propionic acid was detected

TABLE 6
LB. reuteri vegetable blend fermentation 30 DEG C.

| time(h) | 0 | 20 | 44 |
|---|---|---|---|
| lactic acid (g/l) | 0 | 4.66 | 5.96 |
| acetic acid (g/l) | 0 | 2.33 | 2.34 |
| propionic acid (g/l) | 0 | 0 | 0 |
| glucose (g/l) | 11.11 | 2.56 | 0.11 |
| fructose (g/l) | 10.89 | 11.11 | 10.29 |
| vitamin B12 (microgram/l) | | | 1.5 |

### Example 5 Powder According to the Invention

The vegetable paste obtained after fermentation is converted into a powder by heat evaporation. The powder contained 15-30 microgram vitamin B12 per kg powder, 50-100 gr lactic acid per kg, 20-40 gr acetic acid per kg and below 1 gr propionic acid per kg, based on dry weight. The powder can suitably be added to a food or feed product to increase shelf life, nutritional value, in particular vitamin B12 content, or flavour.

1. Method for fermenting vegetables, the method comprising:
(a) providing vegetables;
(b) mixing the vegetables from (a) with a composition comprising Lactobacillus reuteri;
(c) fermenting the mixture obtained in (b) for 24-44 hours, whereby a vegetable paste is obtained,
wherein the mixture is fermented without the addition of water, nutrients, heat or oxygen.

2. Method according to claim 1, wherein the vegetables are fresh vegetables.

3. Method according to claim 1, wherein the vegetables are rejected vegetables.

4. Method according to claim 1, wherein the temperature during fermentation is in the range between 20 and 30 DEG C.

5. Method according to claim 1, wherein the vegetable is tomato, bell pepper, broccoli or white cabbage, or a mixture thereof.

6. Method according to claim 1, wherein the vegetable paste contains 1-8 microgram vitamin B12 per liter paste.

7. Method according to claim 1, which further comprises formulating the vegetable paste into a powder or a liquid.

8. Vegetable paste obtainable by a method according to claim 1.

9. Vegetable paste according to claim 8, comprising 1-8 microgram/l vitamin B12, 2-20 g/l lactic acid, 1-5 g/l acetic acid and less than 0.2 g/l propionic acid.

10. Vegetable paste according to claim 8, comprising between 1 mM and 50 Mm reuterin.

11. (canceled)

12. Use of a vegetable paste, powder or liquid according to claim 9, in a food or feed product.

13. Use according to claim 12, wherein the food product is a vegetable product.

14. Use according to claim 12 in soups, sauces, stews or spreads.

15. Use of a vegetable paste, powder or liquid according to claim 9 in a method for improving flavour, nutritional value or shelf-life of a food or feed product.
